(19) United States
(12) Patent Application Publication
(10) Pub. No.: US 2014/0379554 A1
(43) Pub. Date: Dec. 25, 2014

(54) Report Discrepancy Identification and Improvement

(71) Applicant: Bank of America Corporation, Charlotte, NC (US)

(72) Inventors: Glenn M. Grossman, Matthews, NC (US); Kevin Perry, Charlotte, NC (US); Kimberly Summerrow, Charlotte, NC (US); Elizabeth S. Votaw, Potomac, MD (US); Katherine Dintenfass, Charlotte, NC (US); Aaron R. Leinker, Charlotte, NC (US)

(73) Assignee: Bank of America Corporation, Charlotte, NC (US)

(21) Appl. No.: 13/926,428

(22) Filed: Jun. 25, 2013

(51) Int. Cl. G06Q 40/02

(52) U.S. Cl. CPC G06Q 40/025
USPC 705/38

(57) ABSTRACT

Systems, methods, computer-readable media, and apparatuses for identifying one or more discrepancies between a customer credit report or one or more credit report factors and customer information are presented. A comparison of the credit report factors may be performed to identify any discrepancy and corrective measures may be taken. In some arrangements, one or more improvement options may be identified to improve one or more credit report factors of the customer. The options may be provided to the customer. In other aspects, a comparison of various credit report factors of an individual to a group of individuals may be performed. In some examples, the group may be a peer group identified by an entity performing the comparison. In other examples, the group may be identified by the individual, such as from social media associations or based on a variety of other factors.

### BACKGROUND

Credit reports and credit scores are important tools for understanding a person's financial situation. They are used in a variety of ways and for a variety of purposes. However, inaccuracies in a person's credit report can have a detrimental effect on the person. In addition, many people do not understand how their credit report or credit score compares to their peers. They also might not fully understand the options available to them to improve their credit report or credit score.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses for identifying one or more discrepancies between a customer credit report or one or more credit report factors and customer information. A comparison of the credit report factors may be performed to identify any discrepancy and corrective measures may be taken. In some arrangements, one or more improvement options may be identified to improve one or more credit report factors of the customer. The options may be provided to the customer.

Still other aspects of the disclosure relate to methods, computer-readable media, and apparatuses for comparing various credit report factors of an individual to a group of individuals. In some examples, the group may be a peer group identified by an entity performing the comparison. In other examples, the group may be identified by the individual, such as from social media associations or based on a variety of other factors.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 illustrates an example credit report improvement system according to one or more aspects described herein.

FIG. 3 is an example method of identifying and/or correcting one or more discrepancies in a credit report factor according to one or more aspects described herein.

FIG. 4 is an example method of comparing credit report factors of an individual to a comparison group according to one or more aspects described herein.

FIG. 5 illustrates one example user interface for selecting a comparison group according to one or more aspects described herein.

FIG. 6 is an example user interface identifying one or more discrepancies between the credit report factors and customer information according to one or more aspects described herein.

FIG. 7 is an example user interface identifying one or more improvements that may improve a customer's credit report factors according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

Aspects of the arrangements described herein relate to identifying discrepancies in a credit report of an individual and correcting the discrepancies, as desired. In some arrangements, the system may also identify one or more improvements or improvement options for the individual to implement in order to improve his/her credit report and/or credit score. In still other arrangements, the individual's credit report and/or credit score may be compared to aggregate credit report and/or credit score data for a comparison group. The comparison group may be a peer group. The identification of the comparison group may be performed by the system, such as based on similar age, geographic region, income levels, and the like. Additionally or alternatively, the comparison group may be identified by the individual, such as based on an association via social media or a goal of the individual. Any data of the comparison group may be displayed anonymously and/or in aggregate form such that the personal information of the comparison group is not made public. These and various other aspects will be described more fully below.

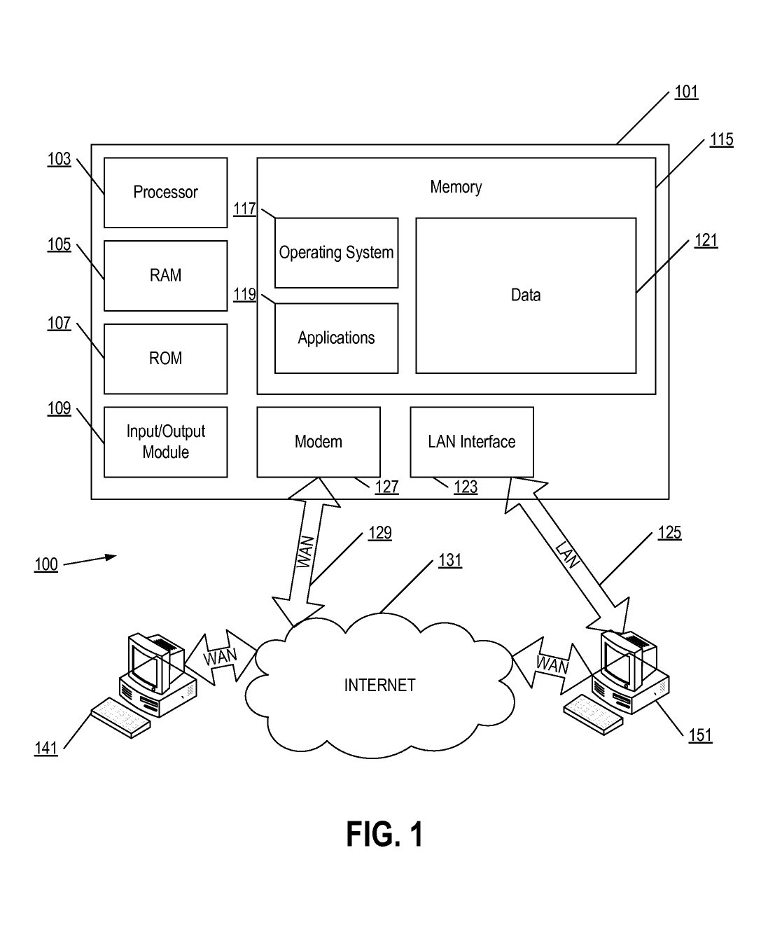

FIG. 1 illustrates an example block diagram of a generic computing device 101 (e.g., a computer server) in an example computing environment 100 that may be used in one or more illustrative embodiments of the disclosure. For example, the generic computing device 101 may correspond to a server in credit report improvement system, as described in examples below. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mobile device, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1 include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, tablet computers, and the like) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

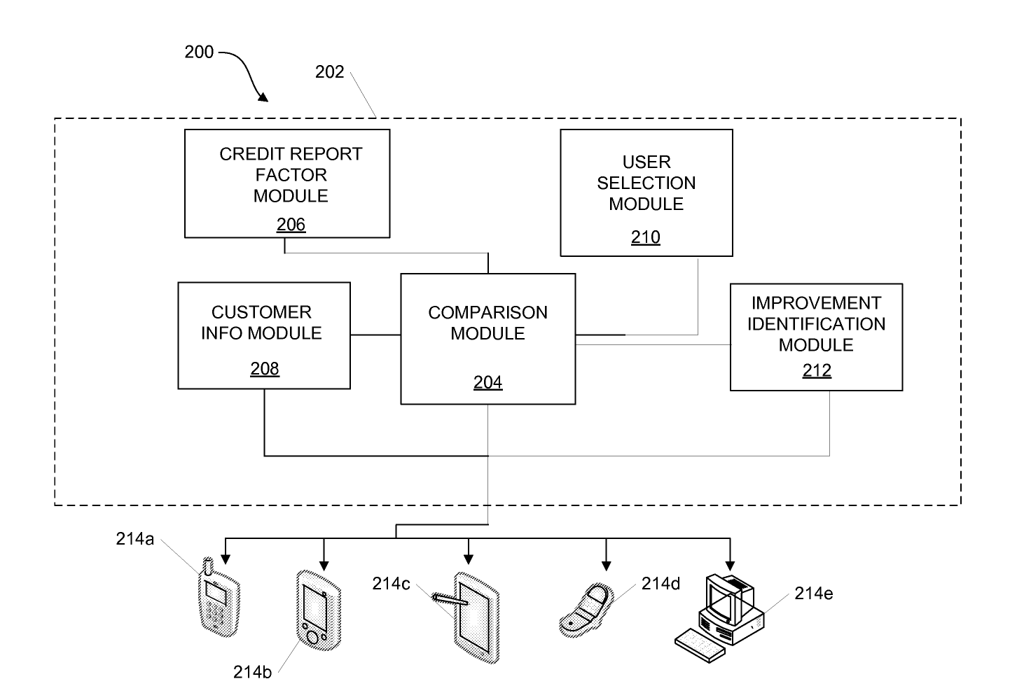

FIG. 2 illustrates one example credit report improvement system 200 according to one or more aspects described herein. In some examples, the credit report improvement system 200 may be part of, internal to or associated with an entity 202. The entity may be a corporation, university, government entity, and the like. In some examples, the entity 202 may be a financial institution, such as a bank. Although various aspects of the disclosure may be described in the context of a financial institution, nothing in the disclosure shall be construed as limiting the credit report improvement system to use within a financial institution. Rather, the system may be implemented by various other types of entities without departing from the invention.

The credit report improvement system 200 may include a credit report factor module 206. The credit report factor module 206 may be implemented in hardware and/or software configured to perform a set of specific functions within the credit report improvement system 200. For instance, the credit report factor module 206 may be configured to receive and/or store data, such as credit report data including, for example, a person's name, unique identifier, credit history, current credit information, credit score, payment history, and the like, and may include one or more algorithms which may be executed by one or more software applications running on generic or specialized hardware within the credit report improvement system. In some arrangements, the credit report data received and/or stored by the credit report factor module 206 may be received from a source external to or not associated with the entity 202. For instance, the information may be received from a third party provider of credit scores or credit reports. The various types of data received by and/or stored by the credit report factor module 206 may represent different credit report factors, such as credit score, payment history, loan or debt history, address history, employment history, and the like. These credit report factors may be compared to similar credit report factors for other individuals, as will be discussed more fully below.

The credit report improvement system 200 may further include a customer information module 208. The customer information module 208 may be implemented in hardware and/or software configured to perform a set of functions within the credit report improvement system 200. The customer information module 208 may store information associated with one or more customers. For instance, the customer information module 208 may store information associated with customers of the entity 202 and may include information received from the customer and/or other information related to the customer. For instance, customer information module 208 may store information such as customer name, address, current employment information, current debt or loan information, current account information, current credit and/or debit card information, and the like. In some examples, the information stored in the customer information module 208 may be information provided by the customer to the entity, such as upon opening an account, applying for a loan or mortgage, and the like.

The credit report improvement system 200 may further include a comparison module 204. The comparison module 204 may be implemented in hardware and/or software configured to perform a set of functions within the credit report improvement system 200. For instance, the comparison module 204 may be in communication with the credit report factor module 206 and customer information module 208 and may receive data therefrom. In some arrangements, comparison module 204 may compare the credit report factors received to the customer information from the customer information module 208 in order to identify any discrepancies in the information. For example, if current address information is incorrect in the credit report factor information (e.g., current address information does not match the current address information stored in the customer information module 208) a discrepancy between the two may be identified. In some examples, the comparison module 204 may compare non-financial data of the credit report factors with non-financial data of the customer information. For example, the comparison module 204 may compare name, address, employment information, and the like.

In some examples, the comparison module 204 may process a correction of any discrepancy identified in the comparison. For instance, continuing the example above, the comparison module 204 may begin the process to correct the current address information in the credit report factors. In some examples, the comparison module 204 may generate any necessary documentation or paperwork needed to correct the discrepancy (e.g., identify correct form for correction, prefill available data, and the like). The customer for which the comparison is being performed may then review, sign, and the like, the paperwork and complete processing of the correction. In some arrangements, the comparison module 204 may automatically begin the process of correcting the identified discrepancy. In other examples, the comparison module 204 may communicate the discrepancy to the customer affected and request user input to proceed with processing the correction.

The customer information module 208 and credit report factor module 206 may further store information related to a plurality of customers of the entity. Accordingly, in some examples, the comparison module 204 may compare not only the credit report factor information of the customer to other customer information for that customer (e.g., a first customer), it may also compare the credit report factor information for the first customer to one or more other customers or groups of customers or other individuals for which comparison information may be obtained. For instance, the credit report factors of the first customer may be compared to credit report factors of a peer group (e.g., individuals having a similar income, individuals in a similar geographic location, individuals having a similar amount of debt or mortgage, and the like). Accordingly, the system 200 may provide comparison information (on an anonymous basis, aggregate basis, and the like) to the first customer to provide the first customer with an indication of how his or her credit report factors compare to their peers. In some examples, the system 200 may indicate general information regarding how the first customer's credit score compares to others. In other examples, the system 200 may indicate how the first customer's level of debt compares to others in the comparison group. Various other types of comparisons and information may be provided to the first customer in order to indicate the financial health of the customer relative to the comparison group. The comparison group information may be provided to the first customer on an anonymous basis and, in some arrangements, the information for the group may be aggregated to provide average values or general ranges of data.

In some examples, the first customer may provide user input identifying a desired comparison group. Accordingly, system 200 may further include user selection module 210. The user selection module 210 may be implemented in hardware and/or software configured to perform various functions within system 200. In some examples, the user input may include identification of a group based on social media. For instance, one or more associates of the customer may be identified as the desired comparison group. The system 200 may then perform the comparison (e.g., by comparison module 204) based on the identified individuals. In other examples, the customer may identify a group of individuals for comparison based on a desired goal of the customer. For instance, the customer may specify the comparison group should include individuals having income above a certain threshold (e.g., a desired goal income amount for the customer) or individuals having debt below a certain threshold. Various other factors may be used in identifying the comparison group, as will be discussed more fully below.

Credit report improvement system may further include improvement identification module 212. Improvement identification module 212 may be implemented in hardware and/or software configured to perform various functions within the credit report improvement system 200. For instance, the improvement identification module 212 may identify one or more improvements that may be implemented by the customer in order to improve the credit report factors, credit score, and the like. For example, if the customer's credit score is below a predetermined threshold, the improvement identification module 212 may identify one or more improvements that the customer may implement in order to raise the credit score above the predetermined threshold. Additionally or alternatively, the improvement identification module 212 may identify one or more improvements that may be implemented by the customer in order to decrease or eliminate a discrepancy identified between the customer and a comparison group. In some examples, the improvement identification module 212 may track a customer's progress toward improving the one or more credit report factors and may transmit a congratulatory message to the customer upon an indication of improvement in the factors, as will be discussed more fully below.

The credit report improvement system 200 may be accessible via one or more computing devices 214a-214e. These devices may be used by one or more customers to communicate with the system 200 in order to request a comparison, identify a comparison group, receive information regarding improvements, discrepancy corrections, and the like. Additionally or alternatively, the devices 214a-214e may be used by administrators, employees, and the like of the entity 202 in order to implement, modify, and the like the system 200. The computing devices may include a smartphone 214a, a personal digital assistance 214b, a tablet computer 214c, a cell phone 214d, or a desktop or laptop computing device 214e. Various other types of computing devices may be used without departing from the invention.

Each of the components or modules of system 200 described above may be implemented in one or more computing devices having some or all of the features and aspects described with respect to computing device 101 in FIG. 1.

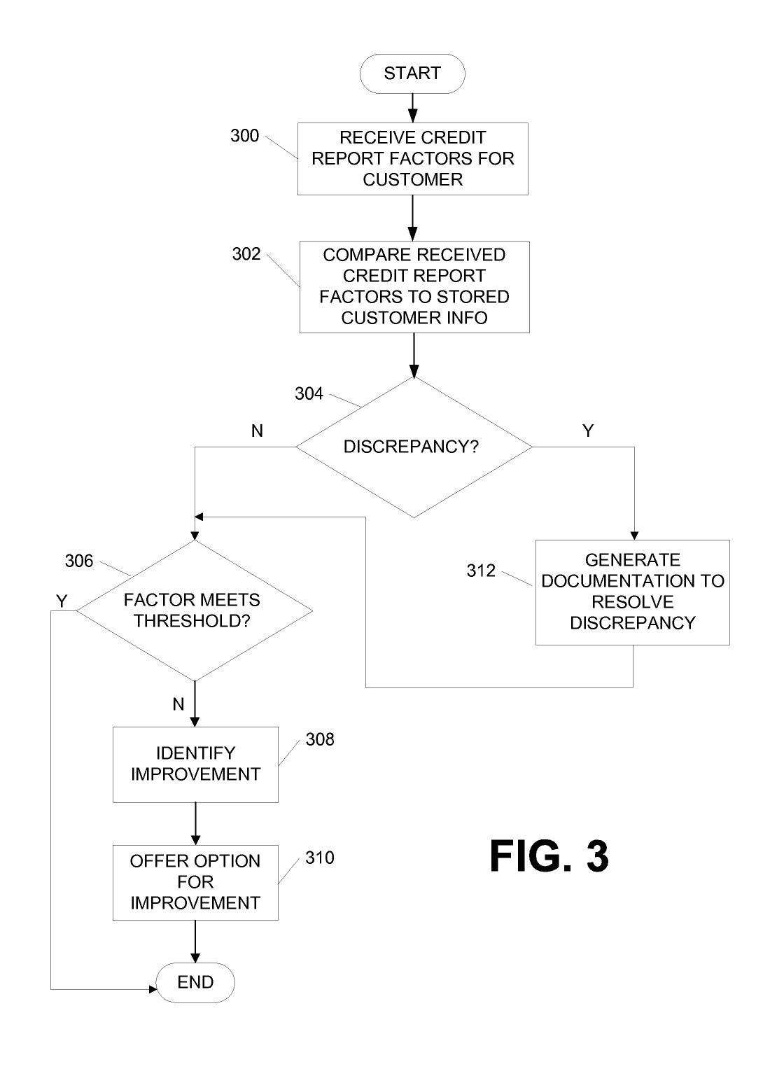

FIG. 3 illustrates one example method of identifying and/or correcting a discrepancy in one or more credit report factors of a customer. In step 300, credit report factors for the customer may be received. As discussed above, the credit report factors may, in some examples, be received from a third party or other source not associated with the entity implementing the method, and may include customer name, address, address history, current employment, employment history, credit score, loan or debt history, payment history, current credit, and the like. In step 302, one or more of the received credit report factors may be compared to customer information known by the entity. For instance, the received credit report factors may be compared to information the customer has provided to the entity, such as when opening an account, obtaining a loan or mortgage, and the like. Some examples of customer information may include name, address, current loans or debt held by the entity, current credit/debit cards/accounts of the customer associated with the entity, and the like.

In step 304, a determination is made as to whether there is a discrepancy between the credit report factor information received and the customer information. For instance, a matching operation may be performed to determine whether the received credit report factors match the customer information stored by the entity. If, in step 304, no discrepancy is identified (e.g., the information matches) a determination may be made in step 306 as to whether one or more of the received credit report factors of the customer meets a predetermined threshold. For instance, a determination may be made as to whether the received credit score of the customer meets a predetermined threshold.

If the received one or more factors does not meet the threshold (e.g., the customer's credit score is below the predetermined threshold) then one or more improvements may be identified in step 308. For instance, improvements such as disputing any discrepancies between the credit report factors and the customer information, reducing debt or outstanding loan or credit balances, opening new accounts, and the like, may be identified as ways to improve the credit report factor not meeting the predetermined threshold. In step 310, an option to implement the identified one or more improvements may be provided to the customer. The option to implement the improvement(s) may include links to one or more websites (e.g., a website to open a new account, make a payment on a loan, and the like). Additionally or alternatively, the options may include detailed information about the one or more improvement options and/or potential outcomes or improvements that may be expected if the improvements are implemented by the customer.

For instance, an estimate of a number of points by which the customer's credit score will increase by implementing one or more of the suggested improvements may be provided. This estimate may be provided by the system as a guideline rather than a guarantee and may be based on data stored by the entity related to other customer's behaviors, improvements in one or more credit report factors, and the like. In some examples, this information may be stored in a look-up table and accessed as desired to quantify the estimated improvement.

If, in step 304, a discrepancy is identified between the received credit report factors and the customer information, the process to resolve the discrepancy may be performed or at least commenced in step 312. In some examples, one or more documents to process the correction of the discrepancy may be generated. The process to correct the discrepancy may be performed automatically (such as by system 200 in FIG. 2) and may include preparing and generating the necessary documentation to complete the correction. The documents may then be transmitted to the customer for approval, signature, and the like. Alternatively, identification of the discrepancy may be transmitted to the customer with an option to proceed with the corrective process. The system may then await input from the customer to proceed and may only begin the correction process upon receiving user input to proceed. The process may then continue to step 306 as described above.

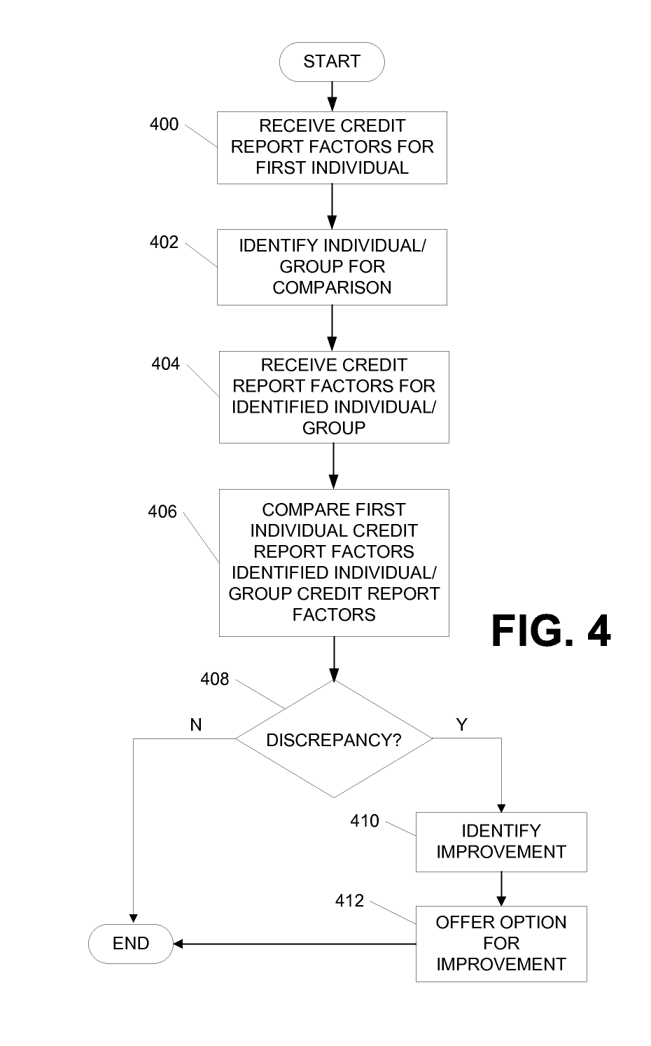

FIG. 4 illustrates one example method of comparing credit report factors of a customer to a comparison group according to one or more aspects described herein. In step 400, credit report factors for a first individual or customer may be received. Similar to the arrangement discussed above, the information may be received from third party sources or sources within the entity implementing the method and may include one or more of the factors discussed above.

In step 402, an individual or group for comparison may be identified. In some examples, the system may automatically generate a group for comparison. The group may be identified based on one or more factors, such as income level, geographic location, age, mortgage amount, and the like. Additionally or alternatively, one or more individuals for comparison, or a group for comparison, may be identified by the first individual (e.g., an individual for which the comparison is being performed and/or who will receive the results of the comparison). In some arrangements, the first individual may identify a group for comparison from, for instance, a social media site. For example, the first individual may identify a group of people associated with the first individual on one or more social media sites as a group for comparison.

Additionally or alternatively, the first individual may identify a goal or success level to achieve. Accordingly, the first individual may request a comparison with one or more individuals already at the goal or success level. For example, the first individual may request a comparison group having an income level above a predetermined amount. The predetermined amount may represent a goal or desired income level of the individual. Additionally or alternatively, the first individual may request a comparison group having a minimum amount of savings. Various other example criteria may be used to identify the comparison individual or group without departing from the invention.

In step 404, credit report factors for the identified comparison individual or group may be received. The credit report factors may be received from a third party or from a source internal to the entity. In step 406, a comparison between the credit report factors of the first individual and the credit report factors of the identified comparison group may be performed. In step 408, a determination is made as to whether there is a shortfall or discrepancy in the comparison. For instance, if one or more credit report factors are different from the comparable credit report factor(s) for the first individual, that factor may be flagged as having a discrepancy. In some arrangements, a discrepancy may be identified if the comparison identifies a factor being outside a predetermined threshold of the value of the comparable factor for the comparison group. For instance, if the credit score of the first individual is within a predetermined threshold of the comparison group score or average score, the item may not be flagged as a discrepancy. Alternatively, if the score of the first individual is outside the threshold, it may be flagged. In some arrangements, the predetermined threshold for a credit score, for example, may be 10 points, 25 points, 50 points, and the like. Thus, if the first individual is within the predetermined number of points, the item will not be flagged, and if it is equal to our outside that number of points, it may be flagged as a discrepancy. Various other thresholds may be applied to the factors being considered.

If no discrepancies are identified in step 408, the process may end. Alternatively, if one or more discrepancies are identified, one or more potential improvements may be identified in step 410. Similar to the arrangement discussed above, the system may identify one or more improvements or ways to reduce or eliminate the discrepancy between the first individual and the comparison individual or group. For instance, if the credit score, or average credit score, of the comparison group is 150 points higher than the first individual, the system may identify improvements that might be implemented by the first individual to bring his/her credit score up to within a predefined threshold of the comparison group's score. In step 412, the one or more identified improvements may be offered to the first individual. Similar to the arrangement discussed above, the option to implement the improvement(s) may include links to one or more websites (e.g., a website to open a new account, make a payment on a loan, and the like). Additionally or alternatively, the options may include detailed information about the one or more improvement options and/or potential outcomes or improvements that may be expected if the improvements are implemented by the customer.

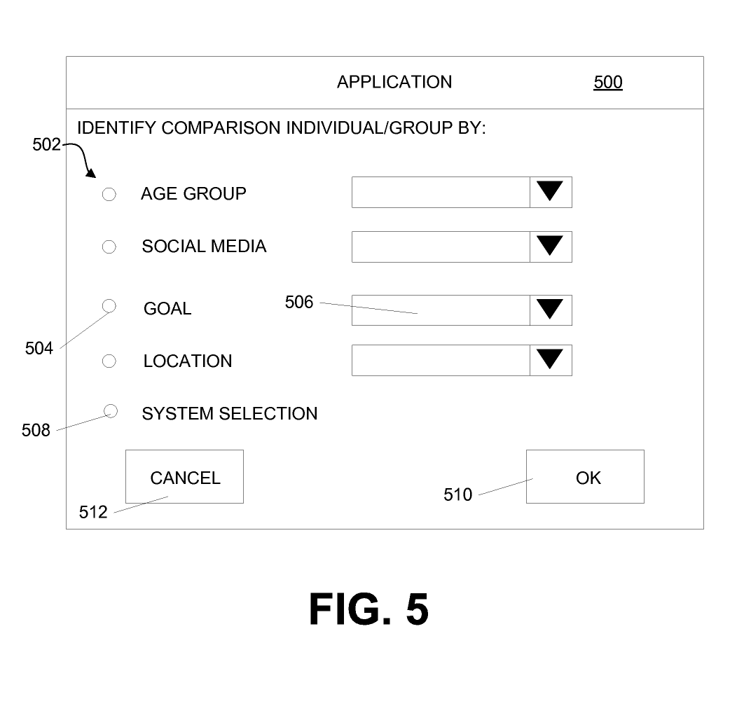

FIG. 5 illustrates one user interface 500 for providing user input selecting an individual or group for comparison. Region 502 includes various criteria that may be used to identify the comparison group or individual. For instance, a user may select a comparison group by age group, social media connection or association, goal (such as income goal, credit score goal, and the like), geographic location (e.g., a well-known zip code, a local area), and the like. Selection of the radio button associated with the desired option may indicate selection of that option. In some arrangements, one or more of the options may include a field to identify the desired group or individual. For instance, selection of radio button 504 will indicate the comparison group may be based on a goal. In field 506, the user may identify the desired goal. The user may select a goal from a drop-down menu or may input the desired goal.

Selection of radio button 508 may prompt the system to identify a comparison group. The system may identify the comparison group based on one or more factors, such as income level, age, geographic location, amount of mortgage, and the like. The system may automatically identify the desired group for comparison.

If the desired selections have been made, a user may select “OK” option 510 to process the selections. Alternatively, the user may select “CANCEL” option 512 to remove any previously made selections and select different options or to return to a previous interface.

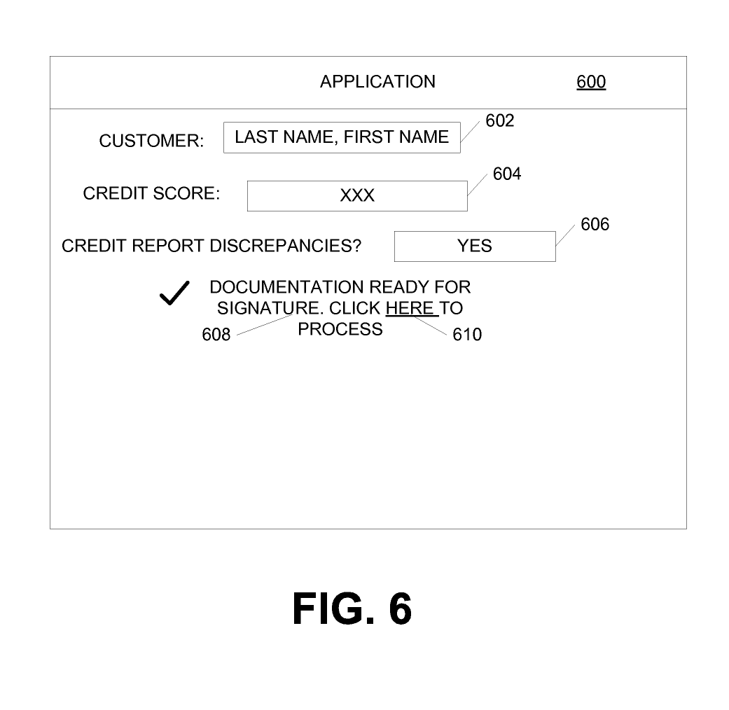

FIG. 6 illustrates one example user interface 600 identifying one or more discrepancies between the credit report factors and the customer information. In field 602 the name or other identifier of the customer is displayed. In some examples, the customer may request the discrepancy analysis between the credit report factors and the customer information. In other examples, the analysis may be performed automatically as a service to the customer. In field 604, the credit score of the customer identified in field 602 is presented. In field 606 there is an indication of whether any discrepancies were identified in the comparison of the received credit report factor information and the customer information. In the example user interface 600, one or more discrepancies were identified and the process for correcting the discrepancies has been commenced by the system. Accordingly, field 608 indicates that the documentation has been prepared and provides a link 610 to complete the documentation.

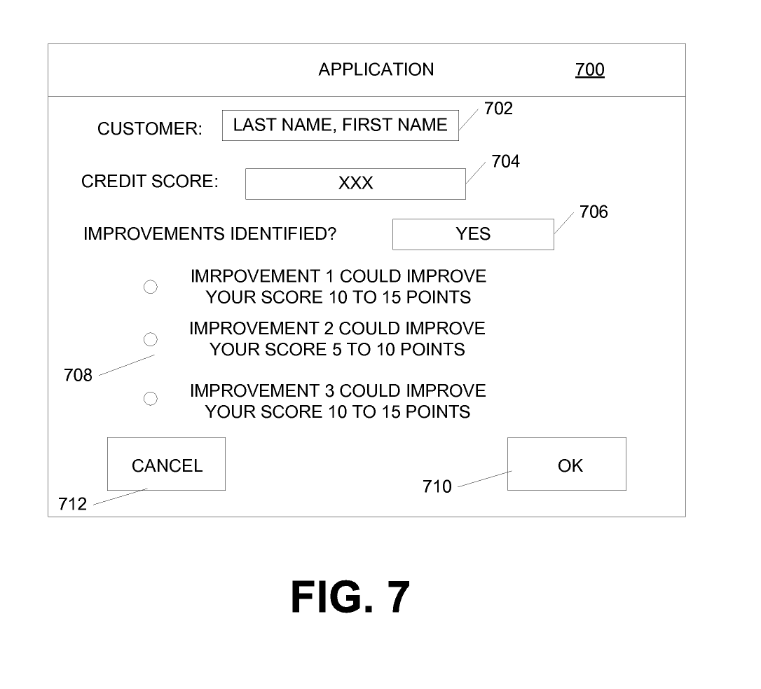

FIG. 7 illustrates one example user interface 700 presenting one or more options for improvement to one or more credit report factors. The user interface includes field 702 identifying the user or customer and field 704 indicating the customer's credit score. Field 706 indicates that one or more improvements or options for improvement are available to the user. Region 708 identifies one or more improvements available and may indicate an estimated amount the improvement, if implemented, may raise the customer's credit score. The user may select one or more improvement by, for example, selecting the radio button associated with the desired improvement. Once the desired selections are made, the user may process the improvements by selecting “OK” option 710 or may cancel the selections made by selecting “CANCEL” option 712.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. An apparatus, comprising:
at least one processor; and
memory storing computer-readable instructions that, when executed by the at least one processor, cause the apparatus to:
receive a plurality of credit report factors for a customer of an entity;
compare the plurality credit report factors for the customer to corresponding information associated with the customer and stored by the entity;
identify, based on the comparison, a discrepancy in the credit report factors for the customer; and
automatically generate documentation to correct the discrepancy.

2. The apparatus of claim 1, further including instructions that, when executed, cause the apparatus to:
determine whether at least one factor of the plurality of credit report factors of the customer meet a predetermined threshold; and
responsive to determining that the at least one credit report factor does not meet the predetermined threshold, identify at least one credit report improvement configured to improve the at least one credit report factor to meet the predetermined threshold; and
provide an option to implement the at least one identified credit report improvement to the customer.

3. The apparatus of claim 1, wherein the information associated with the customer and stored by the entity is information provided to the entity by the customer.

4. The apparatus of claim 1, wherein comparing the plurality of credit report factors to corresponding information associated with the customer includes comparing non-financial credit report factors to non-financial information associated with the customer.

5. The apparatus of claim 4, wherein the non-financial credit report factors include at least one of: address of the customer, employment information of the customer, and name of the customer.

6. One or more non-transitory computer-readable media having computer-executable instructions stored thereon that, when executed, cause at least one computing device to:
receive a plurality of credit report factors for a customer of an entity;
compare the plurality credit report factors for the customer to corresponding information associated with the customer and stored by the entity;
identify, based on the comparison, a discrepancy in the credit report factors for the customer; and
automatically generate documentation to correct the discrepancy.

7. The one or more non-transitory computer-readable media of claim 6, further including instructions that, when executed, cause the at least one computing device to:
determine whether at least one factor of the plurality of credit report factors of the customer meet a predetermined threshold; and
responsive to determining that the at least one credit report factor does not meet the predetermined threshold, identify at least one credit report improvement configured to improve the at least one credit report factor to meet the predetermined threshold; and
provide an option to implement the at least one identified credit report improvement to the customer.

8. The one or more non-transitory computer-readable media of claim 6, wherein the information associated with the customer and stored by the entity is information provided to the entity by the customer.

9. The one or more non-transitory computer-readable media of claim 6, wherein comparing the plurality of credit report factors to corresponding information associated with the customer includes comparing non-financial credit report factors to non-financial information associated with the customer.

10. The one or more non-transitory computer-readable media of claim 9, wherein the non-financial credit report factors include at least one of: address of the customer, employment information of the customer, and name of the customer.

11. An apparatus, comprising:
at least one processor; and
memory storing computer-readable instructions that, when executed by the at least one processor, cause the apparatus to:
receive a plurality of credit report factors for a first individual;
compare the received plurality of credit report factors for the individual with a corresponding plurality of credit report factors associated with at least a second individual;
identify at least one discrepancy between at least one credit report factor of the first individual and a corresponding at least one credit report factor of the at least a second individual based on the comparison;
determine at least one credit report factor improvement configured to reduce or eliminate the identified discrepancy; and
provide an option to implement the at least one credit report improvement to the first individual.

12. The apparatus of claim 11, wherein the at least a second individual is a plurality of individuals.

13. The apparatus of claim 12, wherein comparing the received plurality of credit report factors for the first individual with corresponding plurality of credit report factors associated with at least a second individual further includes:
receiving user input from the first individual identifying the plurality of individuals.

14. The apparatus of claim 13, wherein the received user input includes identification of a group of individuals associated with the first individual on a social media site.

15. The apparatus of claim 13, wherein the received user input includes identification of a group of individuals based on a goal of the first individual.

16. One or more non-transitory computer-readable media having computer-executable instructions stored thereon that, when executed, cause at least one computing device to:
receive a plurality of credit report factors for a first individual;
compare the received plurality of credit report factors for the individual with a corresponding plurality of credit report factors associated with at least a second individual;
identify at least one discrepancy between at least one credit report factor of the first individual and a corresponding at least one credit report factor of the at least a second individual based on the comparison;
determine at least one credit report factor improvement configured to reduce or eliminate the identified discrepancy; and
provide an option to implement the at least one credit report improvement to the first individual.

17. The one or more non-transitory computer-readable media of claim 16, wherein the at least a second individual is a plurality of individuals.

18. The one or more non-transitory computer-readable media of claim 17, wherein comparing the received plurality of credit report factors for the first individual with corresponding plurality of credit report factors associated with at least a second individual further includes:
receiving user input from the first individual identifying the plurality of individuals.

19. The one or more non-transitory computer-readable media of claim 18, wherein the received user input includes identification of a group of individuals associated with the first individual on a social media site.

20. The one or more non-transitory computer-readable media of claim 18, wherein the received user input includes identification of a group of individuals based on a goal of the first individual.
